(19) United States
(12) Patent Application Publication
(10) Pub. No.: US 2026/0326223 A1
(43) Pub. Date: Oct. 22, 2026

(54) ELECTRODE WIRE

(71) Applicant: THERMOCOMPACT, Epagny Metz-Tessy (FR)

(72) Inventor: Michel Ly, Epagny Metz-Tessy (FR)

(73) Assignee: THERMOCOMPACT, Epagny Metz-Tessy (FR)

(21) Appl. No.: 19/491,154

(22) PCT Filed: May 13, 2024
(86) PCT No.: PCT/EP2024/063120

§ 371 Date: Dec. 8, 2025

(30) Foreign Application Priority Data
Jun. 7, 2023 (FR) FR2305740

(51) Int. Cl. B23H 1/06; B23H 7/08; C22C 18/02; C23C 22/52

(52) U.S. Cl. CPC B23H 1/06; B23H 7/08; C22C 18/02; C23C 22/52

(57) ABSTRACT

The electrode wire (2), which is suitable for use as an electrode wire for electroerosion machining, has a metal core (10) extending along a longitudinal axis, and on the metal core, a coating (12) with a zinc oxide mass per unit area greater than 0.5 g/m², the zinc oxide being enriched with chlorine. i.e. the composition of the zinc oxide is [Zn2+, O2-1-x, C1-2x 1, where x is a mole fraction between 0.01 and 0.25.

### FIELD OF THE INVENTION

The invention relates to a electrode wire suitable for use as an electrode wire in EDM machining, and to a method of manufacturing the electrode wire.

Electrode wires are used to cut metals or electrically conductive materials in an EDM machine.

### BACKGROUND ART

The well-known electrical discharge machining (EDM) method removes material from an electrically conductive workpiece by generating sparks in a machining zone between the workpiece and an electrically conductive electrode wire. The electrode wire runs continuously in the vicinity of the workpiece in the direction of the wire length, held by guides, and is progressively moved in the transverse direction towards the workpiece, either by transverse translation of the wire guides, or by translation of the workpiece.

An electrical generator, connected to the electrode wire via electrical contacts away from the machining zone, establishes a suitable potential difference between the electrode wire and the conductive workpiece to be machined. The machining zone between the electrode wire and the workpiece is immersed in a suitable dielectric fluid. The potential difference between the electrode wire and the workpiece generates sparks that progressively erode the workpiece and the electrode wire. The longitudinal movement of the electrode wire ensures that the wire diameter is always sufficient to prevent wire breakage in the machining zone. Relative movement of the wire and workpiece in the transverse direction enables the workpiece to be cut or its surface to be treated, as required.

The particles detached from the electrode wire and the workpiece by the sparks are dispersed in the dielectric fluid, where they are discharged.

To achieve machining precision, especially when making small-radius angle cuts, we need to use small-diameter wires with a high mechanical breaking load to be tensioned in the machining zone and limit the amplitude of vibrations.

Most modern EDM machines are designed to use metal wires, typically 0.25 mm in diameter, with a breaking load of between 700 N/mm² and 1,000 N/mm².

When a spark occurs between the electrode wire and the workpiece, the surface of the electrode wire is suddenly heated to a very high temperature for a short time. As a result, the material in the surface layer of the electrode wire at the site of the spark changes from solid to liquid or gas, and is displaced on the electrode wire surface and/or discharged into the dielectric fluid. It can be seen that the outer face of the electrode wire affected by the spark has been deformed, generally taking on a slightly concave crater shape, with zones where the material has been melted and solidified again.

It has been shown that the efficiency of spark erosion depends largely on the nature and topography of the electrode wire surface layer. For this reason, considerable progress in EDM efficiency has been achieved using electrode wires comprising:
a metal core made of one or more metals or alloys ensuring good conduction of the electric current and good mechanical strength to hold the mechanical tensile load of the wire, and
a coating of one or more other metals or alloys and/or a particular topography, e.g. fractures, ensuring improved EDM efficiency, e.g. higher erosion speed.

For example, patent JPH0261076 discloses the creation of an oxide layer on the surface of an electrode wire to speed up machining. Other prior art are known from U.S. Pat. No. 8,378,247B2 et US2022/212277A1.

### SUMMARY OF THE INVENTION

The invention aims to further improve the machining speed of electrode wires with an oxide-containing coating, in particular zinc oxide.

The invention is set out in the attached set of claims.

### BRIEF DESCRIPTION OF THE DRAWINGS

The invention will be better understood on reading the following description, given solely by way of non-limiting example and made with reference to the drawings on which:

FIG. 1 is a schematic illustration of the cross-section of an electrode wire,

FIGS. 2, 3 and 4 are flowcharts, respectively, of a first, second and third methods for manufacturing the electrode wire shown in FIG. 1,

FIG. 5 is a partial schematic illustration of a cross-section of another electrode wire, and

FIG. 6 is a flowchart of a method for manufacturing the electrode wire shown in FIG. 5.

### DETAILED DESCRIPTION OF PARTICULAR EMBODIMENTS

In these figures, the same references are used to designate the same elements. In the remainder of this description, features and functions well known to the skilled person are not described in detail.

In Chapter I, definitions of certain terms are given. In Chapter II, examples of detailed embodiments are described with reference to the figures. Then, in Chapter III, variants of these embodiments are presented. Finally, in Chapter IV, the advantages of the various embodiments are described.

### CHAPTER I: DEFINITIONS AND TERMINOLOGY

The expression “element made of material A” or “material A element” designates an element in which material A represents at least 70%, by mass, of this element and preferably at least 90% or 95% by mass of this element.

A “copper-zinc alloy” is an alloy made entirely of copper and zinc, apart from unavoidable impurities. A copper-zinc alloy is also called “brass”.

A copper-zinc alloy “phase” refers to a solid phase of the copper-zinc alloy with a particular crystallographic structure. More precisely, the phases of the copper-zinc system are distinguished from one another by their composition and by their particular crystallographic structure. This particular crystallographic structure makes it possible to distinguish a phase of the copper-zinc alloy from a simple mixture of fine copper and zinc grains, which would have the same overall composition. Typical known copper-zinc alloy phases are alpha, beta, gamma, delta, epsilon and eta. The particular crystallographic structure of a phase can be identified by various means. For example, optical microphotographs or metallography of polished samples show different shades of color for each phase, provided the sample has been properly etched. For example, to distinguish the gamma phase from the epsilon phase, the sample is etched with “Nital”, a solution of 3% nitric acid diluted in ethanol. The gamma phase then appears gray when it is low in zinc, and grayish with shades of brown when it is high in zinc. The epsilon phase appears darker brown. The gamma phase can also be distinguished from the epsilon phase by observing the sample under a scanning electron microscope, using a backscattered electron detector. It is also possible to identify the phase of a sample by X-ray diffraction. In the latter case, the wire sample is placed under an incident beam of X-rays of a specific wavelength. For example, the Kα line of copper is used, with an average wavelength of 0.1541 nm. The intensity of the diffracted rays is evaluated for each diffraction angle. The gamma phase has a known X-ray diffraction spectrum, different from that of the other phases in the copper-zinc system, and from the zinc oxide ZnO often found on wire surfaces. If the copper-zinc alloy is not crystallized in the form of at least one of the alpha, beta, gamma, delta, epsilon or eta phases, it is amorphous, and the X-ray diffraction pattern shows flattened bumps rather than prominent peaks. At a given temperature, the different phases of the copper-zinc alloy each correspond to a specific range of zinc concentration. The extent of each of these specific zinc concentration ranges varies with temperature.

The concentration of an element in a sample can be obtained by compositional microanalysis and, in particular, by energy-dispersive X-ray spectroscopy (EDS or EDXS). Compositional microanalysis is performed using a scanning electron microscope equipped with a spectrometry probe. A beam of electrons, accelerated in an electric field of 20 KV, for example, impacts the surface of the sample, causing it to emit X-rays. These X-rays have an energy spectrum characteristic of the composition of the sample surface impacted by the electron beam. With an energy dispersive spectrometry (EDS) or wavelength selective spectrometry (WDS) probe, the spectrum of X-rays emitted by the sample surface is measured. Algorithms are used to select the elements to be analyzed (thus eliminating the effect of impurities), and to calculate the composition of the sample impacted by the electron beam, based on the measured spectra. It should be noted that, due to the interactions between X-rays and matter, the volume analyzed by EDS (or WDS) is generally around one cubic micrometer. At the boundary between two zones of different composition, an average concentration may be measured that does not actually exist in either zone. To avoid this problem, the compositions shown are measured in areas larger than one-micrometer cubes, and at points in these analyzed areas away from the boundaries with other unanalyzed areas.

The expression “the concentration of an element within a zone is greater than X atomic %” means that the average concentration of this element within this zone is greater than X atomic % (at. %). An average concentration is obtained, for example, by measuring the concentration of this element at different locations within this zone and then averaging these concentration measurements. The locations where the measurements are taken are at the points where the concentration is likely to be lowest, at the points where the concentration is likely to be close to the average, and at the points where the concentration is likely to be highest. Typically, the measurement locations are distributed along an axis passing through the electrode wire axis.

The term “electrically conductive” refers to a material whose electrical conductivity at 20 °C is greater than 106 S/m, and preferably greater than 107 S/m.

The longitudinal axis of a wire is the axis along which the wire mainly extends.

The term “cross-section” refers to a section of the electrode wire perpendicular to its longitudinal axis.

The term “longitudinal section” refers to a section of the electrode wire made along a plane containing its longitudinal axis.

The term “layer” refers to an annular layer of the electrode wire that lies, in each cross-section of the electrode wire, between an inner and an outer circular boundary. In reality, these boundaries are not perfect circles. However, as a first approximation, in this text, these boundaries are assimilated to circles. These circular boundaries are both centered on the electrode wire axis. The inner circular boundary is the boundary of the layer closest to the electrode wire axis. Conversely, the outer circular boundary is the boundary of the layer furthest from the electrode wire axis. Between these inner and outer circular boundaries, the chemical composition is substantially homogeneous. Conversely, at the inner and outer circular boundaries, the chemical composition changes abruptly. In particular, the change in composition when these circular boundaries are crossed is far greater than the slight changes in composition that can be observed within a layer.

A “uniform” layer is one formed from a material which, in a cross-section of the wire, extends continuously or virtually continuously around the axis of the wire and within this layer. Thus, a uniform layer does not have a multitude of fractures that partition it into a multitude of blocks separated from one another, in a longitudinal section of the wire, by these very large radial fractures. A very large number of radial fractures means, over a length of 1 mm of the electrode wire, more than a dozen radial fractures which divide the layer in question into a dozen blocks mechanically isolated from one another, in the longitudinal section, by these radial fractures.

The term “fractured layer” refers to a layer with a multitude of fractures that partition it into a multitude of blocks separated from one another, in a longitudinal section of the wire, by a large number of radial fractures. The composition of these blocks is different from that of the adjacent layer beneath the fractured layer, or from that of the metal core immediately beneath the fractured layer. The majority of the blocks in a fractured layer are longer than the thickness of the fractured layer. Here, the majority of blocks in a fractured layer are longer than 5 μm or 10 μm. In this text, the length and width of a block, in a cross-section, are defined as being equal, respectively, to the length and width of the rectangle of smallest area which entirely contains this block.

A “radial fracture” is a fracture that extends mainly, within an electrode wire cross-section, in a radial direction.

The term “surface layer” refers to the outermost layer of the electrode wire. This surface layer may have a thin film of residues on its surface, such as drawing lubricant residues. The outer face of this surface layer is therefore either merged with the outer face of the electrode wire in the absence of the thin film, or separated from the outer face of the electrode wire solely by this thin film.

Ambient temperature” refers to a temperature between 15 °C and 35 °C, typically 25 °C.

The average thickness e of a zinc oxide surface layer is defined by the following relationship (1): e=[mᵢ−m_{f}]/[ρ*π*d*L], where:
mᵢ is the initial mass of a wire sample with a zinc oxide surface layer,
m_{f} is the mass of the same wire sample after being immersed in a bath that completely dissolves the surface layer of zinc oxide,
ρ is the density by volume of the zinc oxide, enriched or not with chlorine, this density p being taken here equal to 5600 kg/m³,
π is the number pi,
d is the initial diameter of the wire sample before being immersed in the bath which completely dissolves the oxide layer,
L is the length of the wire sample, and
*″ is the symbol for scalar multiplication.

The average thickness e is, for example, measured using the following procedure:
1) A sample of wire length L and diameter d is taken and wound into a coil of approximately 5 cm diameter. Length L is, for example, 12 m. The diameter d is often equal to 0.25 mm.
2) The sample is rinsed with water, then dried and dusted with compressed air.
3) The initial mass mᵢ of the sample is measured using a precision balance.
4) The sample is then soaked for 20 to 30 seconds in a stirred aqueous bath of 8% to 12% sulfuric acid, at a temperature of 42 °C to 48 °C.
5) The sample is rinsed with water.
6) The sample is dried using a jet of compressed air.
7) The final mass m_{f} of the sample is measured using a precision balance.
8) The average thickness e of the sample is calculated using relationship (1) above. Unless otherwise specified, in the remainder of this text, the term “zinc oxide layer thickness” alone refers to the average thickness of the zinc oxide layer.

The average quantity q_{ZnO} of zinc oxide contained in a surface layer is defined by the following relationship (2): q_{ZnO}=[mᵢ−m_{f}]/[π*d*L]. The initial mass mᵢ and the final mass m_{f} are, for example, measured using the same procedure as described for measuring the thickness e of a zinc oxide surface layer. Hereafter, the quantity q_{ZnO} is expressed in g/m². Since the quantity q_{ZnO} is expressed in g/m², it is a mass per unit area. Thus, in this text, the terms “quantity q_{ZnO}” and “mass per unit area q_{ZnO}” refer to the same thing. Unless otherwise specified, in the remainder of this text, the term “zinc oxide quantity” alone refers to the average quantity of zinc oxide calculated using relationship (2).

The average quantity q_{ZnCl2} of zinc chloride (ZnCl₂) deposited on the surface of a wire after it has been soaked in an aqueous solution of this salt is defined by the following relationship (3): q_{ZnCl2}=[C/(1+C)]*[m_{fCl}−m_{iCl}]/[π*d*L], where:
C is the zinc chloride concentration of the aqueous solution expressed in kg/l, C being equal to the mass of zinc chloride, expressed in kg, dissolved in 1 liter of water,
m_{fCl} is the final mass of a sample of wire on whose surface zinc chloride has been deposited by dipping the wire in an aqueous solution of this salt,
m_{iCl} is the initial mass of the same wire sample before soaking in the aqueous zinc chloride solution,
π is the number pi,
d is the initial diameter of the wire sample before being dipped in the aqueous zinc chloride solution,
L is the length of the wire sample.

The average quantity q_{ZnCl2} is, for example, measured using the following method:
1) A sample of wire length L and diameter d is taken and wound into a coil of approximately 5 cm diameter. Length L is, for example, 12 m.
2) The sample is rinsed with water, then dried and dusted with compressed air.
3) The initial mass m_{iCl} of the sample is measured using a precision balance.
4) Zinc chloride is then deposited on the surface of this sample by dipping it in an aqueous zinc chloride solution.
5) The sample is drained to remove any drops of solution still clinging to the sample. It is not dried, as zinc chloride is too hygroscopic.
6) The final mass m_{fCl} of the sample is measured using a precision balance.
8) The average quantity q_{ZnCl2} is calculated using relationship (3) above. Hereafter, the quantity q_{ZnCl2} is expressed in g/m². Unless otherwise specified, in the remainder of this text, the term “quantity of zinc chloride deposited on a wire” alone refers to the average quantity of zinc chloride calculated using relationship (3).

### CHAPTER II: EXAMPLES OF REALIZATION MODES

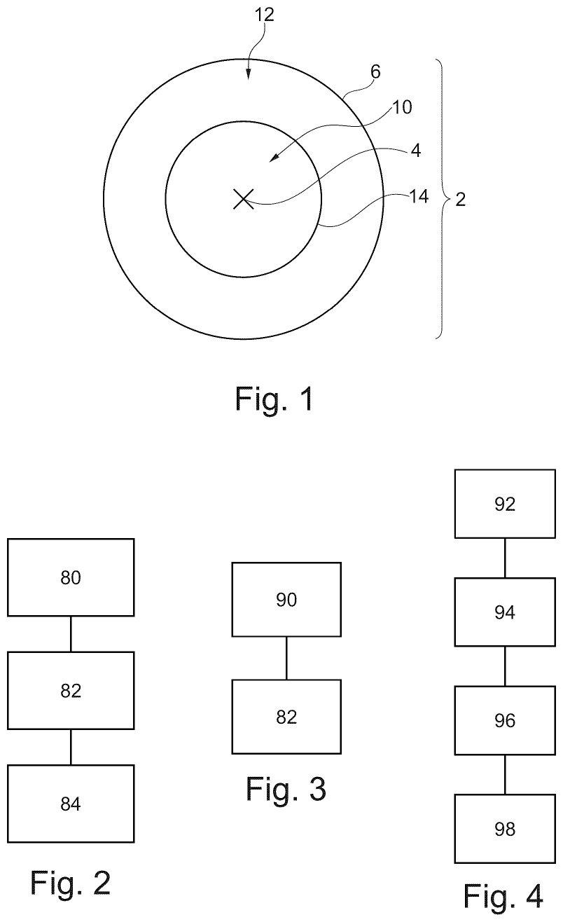

FIG. 1 shows an electrode wire 2 for EDM machining as described in the introductory section of this text.

To this end, the electrode wire 2 has a breaking load greater than 400 N/mm² or 700 N/mm² and, generally, less than 1100 N/mm². Wire 2 extends along a longitudinal axis 4. Axis 4 is perpendicular to the sheet plane. The length of wire 2 is greater than 1 m and, typically, greater than 10 m or 50 m.

Wire 2 has an outer face 6 which is directly exposed to sparks when machining a workpiece by electrical discharge machining (EDM) using this wire. The outer face 6 is cylindrical and extends along axis 4. The directrix curve of face 6 is mainly a circle centered on axis 4. Thus, the cross-section of wire 2 is circular. The outer diameter D₂ of wire 2 is typically between 50 μm and 1 mm, and more often between 70 μm and 400 μm. Here, the diameter D₂ is 0.25 mm.

In this embodiment, the wire 2 comprises:
a central core 10 made of electrically conductive material, and
a coating 12 applied directly to the core 10.

The function of core 10 is to ensure, on its own, most of the breaking load of wire 2. It also ensures the electrical conductivity of wire 2. For this purpose, it is made of an electrically conductive material. Typically, it is made of metal or a metal alloy.

Core 10 has a mainly cylindrical peripheral face 14 extending along axis 4. This peripheral face 14 is made of a copper-zinc alloy. In this example, core 10 is made entirely of a single copper-zinc alloy. For example, the single copper-zinc alloy of core 10 is an α-phase copper-zinc alloy or a copper-zinc alloy formed from a mixture of a and β phases. In particular, core 10 does not have a central portion of copper-zinc alloy in one phase covered by a layer of copper-zinc alloy in another phase. Typically, the zinc concentration in core 10 is greater than 20 atomic % and, preferably, greater than or equal to 36 atomic % or 40 atomic %. Typically, the zinc concentration in core 10 is less than 42 atomic %.

Coating 12 is designed to increase machining speed and thus the erosive efficiency of the electrode wire and/or the quality of the faces of the part obtained after EDM machining. The lower the roughness, the better the quality of an EDM-cut face.

For this purpose, coating 12 contains zinc oxide in a quantity greater than 0.5 g/m² or 1 g/m². The amount of zinc oxide may also be greater than 3 g/m² or 5 g/m². Generally, the amount of zinc oxide in coating 12 is less than 100 g/m² or 50 g/m² and, more often, less than 10 g/m².

In this embodiment, layer 12 is essentially made of zinc oxide. In places, however, the layer 12 can be penetrated by brass spikes. These brass spikes form protrusions on the peripheral face 14 of the core 10, which penetrate the layer 12. These brass spikes form a single block of material with the core 10.

More precisely, the zinc oxide contained in coating 12 is chlorine-enriched zinc oxide of the formula [Zn²⁺, O²⁻₁₋ₓ, Cl⁻₂ₓ], where x is a mole fraction of between 0.01 and 0.15 or between 0.01 and 0.2 or between 0.01 and 0.25. Preferably, the mole fraction x is greater than 0.02 or 0.03. Also, preferably, the mole fraction x is less than or equal to 0.2 or 0.13. Chlorine-enriched zinc oxide may or may not be partially hydrated. Analysis by energy dispersive spectrometry (EDS) or wavelength selective spectrometry (WDS) gives essentially the same results in the case of chlorine-enriched zinc oxide whether or not it is hydrated. Hereinafter, the composition of chlorine-enriched zinc oxide is given without taking water molecules into account.

In this first embodiment, the coating 12 consists of a single layer of zinc oxide. Hereafter, the same numerical reference is used to designate both the coating 12 and the zinc oxide layer. Layer 12 is the surface layer of the electrode wire 2.

The average thickness of layer 12 is very small compared with the diameter D₂ of wire 2, i.e. less than 0.5% of diameter D₂ and preferably less than 0.25% of diameter D₂.

The average thickness e₁₂ of layer 12 is between 100 nm and 522 nm, preferably between 100 nm and 400 nm or between 100 nm and 300 nm.

Compositional analyses using XPS (X-ray Photoectron Spectroscopy) spectra have shown that the zinc oxide in layer 12 is composed, in atomic percentages:
more than 90% zinc, oxygen and chlorine, and
the remainder being copper and various manufacturing residues.

In these composition analyses, the presence of water, carbon and carbon compounds on the surface of layer 12 was not taken into account. In fact, this carbon comes from the lubricant used during the wire-drawing stage. According to the analyses carried out, it is submitted that the zinc oxide corresponds to zincite.

A first method for manufacturing wire 2 will now be described with reference to FIG. 2.

To implement this manufacturing method, typically the desired thickness e₁₂ is first selected between 100 nm and 522 nm. For example, here the thickness e₁₂ is taken to be equal to 200 nm. Next, the value of a coefficient c₁ described later is chosen between 1.15 and 6. For example, here the coefficient c₁ is chosen equal to two. Finally, a diameter Do is chosen as a function of the previously chosen coefficient c₁ and the desired final diameter D₂, while complying with the constraints set out in the following paragraph. By way of illustration, the final diameter D₂ is taken to be equal to 0.25 mm.

In a step 80, a brass blank wire is first provided. The blank wire is a brass wire with a diameter D₀ between 1.15*D₂ and 6*D₂ and, preferably, between 2*D₂ and 6*D₂. In this example, the diameter D₂ is equal to 0.25 mm so that the diameter D₀ is between 0.288 mm and 1.5 mm and, preferably, between 0.5 mm and 1.5 mm. Here, the diameter Do is taken to be 0.5 mm.

The zinc concentration of this blank wire is chosen as described above for core 10. Here, the zinc concentration of the blank wire is 40 atomic %. The higher the zinc concentration, the better the performance of wire 2.

In this embodiment, the blank wire with the desired diameter D₀ is obtained by drawing a brass wire of standard diameter Dᵢₙᵢ to the desired diameter D₀. For example, the diameter Dᵢₙᵢ is 1.25 mm.

Then, in a step 82, the blank wire is oxidized to obtain an oxidized blank wire. The oxidized blank wire has a layer of zinc oxide directly on its peripheral face. This zinc oxide layer completely covers the peripheral face of the oxidized blank wire. To this end, in step 82, the supplied blank wire is subjected to a heat treatment in the presence of oxygen and chlorine. This heat treatment is carried out in a gaseous medium containing oxygen and at a pressure in excess of 50 kPa or 100 kPa. Here, this heat treatment is simply carried out in the earth's atmosphere, i.e. in a gaseous medium containing more than 20%, by volume, of oxygen, at ambient pressure of around 101 kPa.

To ensure that chlorine is present during heat treatment, the blank wire is soaked in an aqueous zinc chloride solution prior to the start of heat treatment. The concentration of zinc chloride in the solution ensures that more than 0.5 g/m² or 1 g/m² of zinc chloride is deposited on the outside of the blank wire. The amount of zinc chloride deposited on the outside of the blank wire is preferably greater than 5 g/m² or 10 g/m². Here, the temperature of the aqueous zinc chloride solution is equal to room temperature and the concentration of zinc chloride in the solution is equal to 250 g/l. The blank wire is soaked in this solution for a period longer than 1 s. Here, the soaking time is between 1 s and 10 s and, preferably, between 3 s and 6 s. Throughout the soaking time, the solution is agitated to ensure a homogeneous concentration of zinc chloride. The zinc wire runs through the aqueous zinc chloride solution, for example, at a speed of 2 m/s. After being dipped in the zinc chloride solution, the blank wire is drained to remove any drops of solution that may remain on its surface and thus avoid local excesses of zinc chloride on the outside of the blank wire. Under these conditions, the amount of zinc chloride ZnCl₂ deposited on the outside of the blank wire is around 6 g/m².

The zinc chloride-coated blank wire is then wound onto a steel coil, and the steel coil is placed in an oven, under air and at ambient pressure, to apply the heat treatment. Here, the furnace is not airtight, and air is circulated throughout the heat treatment process.

Here, this heat treatment is configured to generate a layer of zinc oxide on the peripheral face of the blank wire whose average thickness e₀ is between 115 nm and 600 nm. Indeed, a thickness e₀ of less than 115 nm does not enable a thickness e₁₂ of 100 nm or more to be obtained after the drawing step 84 described below. On the other hand, it has been observed that a thickness e₀ greater than 600 nm leads to a zinc oxide layer that does not adhere well and is stripped off, at least in places, during drawing step 84. This stripping off of part of the zinc oxide layer during drawing step 84 constitutes a waste of material that should be avoided or limited, since the stripped-off zinc oxide is not used in the manufactured wire 2.

Within the range [115 nm; 600 nm], the thickness e₀ is determined by successive experiments, testing several thicknesses e₀ within this range, until the thickness e₀ is found which, after wire drawing, gives the desired thickness e₁₂ of zinc oxide. In particular, when determining the thickness e₀, it must be borne in mind that, even if the thickness e₀ remains below 600 nm, a fraction of the zinc oxide is stripped off during the drawing stage. It has been estimated that, at present, this fraction of zinc oxide can be as high as 45% or 30%. It should be emphasized that such a fraction of zinc oxide lost during the drawing process remains much lower than the fraction of zinc oxide lost if the thickness e₀ were chosen to be greater than 600 nm or 800 nm. Indeed, for a thickness e₀ greater than 600 nm or 800 nm, the fraction of zinc oxide lost during drawing is greater than 60% or 75%. Typically, the e₀ thicknesses tested are chosen in the range [c₁*e₁₂; Min (1.8*c₁*e₁₂; 600)] and preferably in the range [1.2*c₁*e₁₂; Min (1.8**c₁*e₁₂; 600)] and even more often in the range [1.35*c₁*e₁₂; Min (1.7*c₁*e₁₂; 600)], where:
c₁ is equal to the diameter reduction coefficient of the oxidized blank wire in drawing step 84, and
Min (a;b) is the function that returns the smallest of the values a and b.

The reduction coefficient c₁ is defined as the ratio D₀/D₂. Thus, when the thickness e₁₂ is equal to 200 nm and the coefficient c₁ is equal to two, the thickness e₀ which makes it possible to obtain the desired thickness e₁₂ after drawing is typically between 540 nm and 600 nm.

The heat treatment parameters to be configured are the temporal evolution of the furnace temperature T_{four} during the heat treatment and the total duration D_{four} of this heat treatment. Here, to simplify the adjustment of heat treatment parameters, the temperature T four is chosen to be constant throughout the duration D_{four}.

In the range from 130 °C to 260 °C for the temperature T_{four}, the oxidation kinetics of zinc chloride-coated brass are only slightly temperature-dependent. The thickness e₀ of the chloride-doped zinc oxide layer appears to increase as a function of the square root of time, according to the following relationship (4):

$${e}_{0} = {e}_{0}^{ini} + \sqrt{2 * K * t} ,$$

$$where :$$

$$K = 2.68 * {10}^{- 19} {m}^{2} / s ,$$

$$t is duration ,$$

$${e}_{0}^{ini} is the thickness {e}_{0} at time t = 0 ,$$

$$the “ * ” symbol denotes scalar multiplication .$$

Using relationship (4), it is possible to estimate a theoretical value D_{fourT} of duration D_{four} to obtain a given thickness e₀. Subsequently, several trials with different values of the duration D_{four} chosen around the theoretical value D_{fourT} may be necessary to obtain the precise value of the duration D_{four} which makes it possible to obtain exactly the desired thickness e₀. Typically, the D_{four} duration value selected as a result of these tests is in the range [0.8*D_{fourT}; 1.2*D_{fourT}] or in the range [0.9*D_{fourT}; 1.1*D_{fourT}] or in the range [0.95*D_{fourT}; 1.05*D_{fourT}].

The duration D_{four} is advantageously chosen to be greater than four or six hours to ensure that the temperature is evenly distributed throughout the coil.

At the end of duration D_{four}, the coil of blank wire is removed from the furnace. At this point, the blank wire is covered with a layer of zinc oxide of thickness e₀. It is therefore referred to as “oxidized blank wire”. After removal from the furnace, the coil is cooled. Typically, this involves exposing the coil to ambient air for the duration required to cool it down to room temperature. This completes step 82.

In step 82, zinc oxidation consumes the zinc present in the brass. As a result, the zinc concentration in the brass core of the blank wire near the zinc oxide layer is generally lower than in the brass near axis 4.

Then, in step 84, the oxidized and cooled blank wire is cold-drawn to produce wire 2. “Cold” refers to the fact that drawing step 84 is carried out without heating the blank wire prior to diameter reduction. During step 84, the diameter reduction coefficient c₁ is used to bring the diameter D₀ of the blank wire to the desired diameter D₂ for wire 2, i.e. a diameter of 0.25 mm.

Here, in step 84, the oxidized blank wire is drawn under the same conditions as those suitable for non-oxidized brass wire. Diameter reduction is achieved by passing the oxidized blank wire successively through several dies of decreasing diameter, so as to progressively reduce the diameter of the oxidized blank wire until the desired diameter D₂ is reached. For example, dies with elongations of between 15% and 22% are used. A water-soluble lubricant is used to draw the oxidized blank wire. Here, for example, the lubricant is an aqueous solution containing the water-soluble lubricant.

It is this drawing that can create the brass peaks that penetrate layer 12.

After step 84, once the diameter D₂ has been reached, in-line stress-relief annealing is carried out before winding. This stress-relief annealing minimizes residual stresses in the wire 2, resulting in a fairly straight wire when a one-meter length is hung vertically from its upper end. This makes it easier to thread the electrode wire into the processing machine. This stress-relief annealing does not alter the structure of wire 2, and has little effect on its tensile strength. Typically, the temperature for stress relief annealing is between 250 °C and 450 °C, and the duration is less than a tenth of a second.

It is emphasized that in step 82, the temperature T_{four} is low enough that, under the effect of the heat treatment, the brass does not recrystallize, so that the breaking load of the oxidized blank wire is greater than 700 N/mm². The coefficient c₁ can therefore be as small as desired. On the other hand, to increase the breaking load of the oxidized blank wire, the coefficient c₁ is chosen to be greater than or equal to 1.3 or 1.6. The coefficient c₁ should also preferably be less than 6 so that the thickness e₀ remains less than 600 nm when the thickness e₁₂ is equal to 100 nm.

To demonstrate the benefits of an electrode wire with a surface layer of chlorine-enriched zinc oxide, the following tests were carried out. A reference EDM machining job was defined. This involved cutting a punch out of a 50 mm-high piece of steel, with guideways located less than 0.2 mm from the workpiece. Cutting is carried out on a CUT200MS machine marketed by GF Machining Solution. Cutting is carried out in three machining passes, using a technology adapted to brass. During each pass, the speed of movement of the part in relation to the electrode wire was adapted to cut the punch as quickly as possible with the same final surface finish. Here, this final surface finish corresponds to a roughness Ra of 0.6 μm. More precisely, in the tests carried out, only the speeds of movement of the workpiece relative to the electrode wire in the first and second passes were adapted according to the wire used. The speed of movement of the part in relation to the electrode wire in the third pass is the same for all the tests carried out.

Using the manufacturing method shown in FIG. 2, a first wire was produced. Subsequently, a second wire was manufactured using exactly the same manufacturing method as that used to obtain the first wire, except that in step 82, soaking of the blank wire in the zinc chloride solution was omitted. As a result, the heat treatment used to manufacture this second wire is carried out in the absence of chlorine. As a result, the oxide layer thickness of the second wire is different from the thickness e₁₂ of the first wire.

Punch machining times using the first and second wires were measured. The amount of zinc oxide in the first and second wires was also measured. To eliminate variations in machining speed that could be explained simply by the fact that the zinc oxide layer thicknesses of the first and second wires are different, for each wire the machining efficiency E defined by the following relationship was calculated: E=G/q_{ZnO}, where G and q_{ZnO} are, respectively, the measured time gain and the measured amount of zinc oxide in that wire. The time gain G is calculated using the following relationship: G=1−(tᵤ/t_{ref}), where:
tᵤ is the measured machining time,
t_{ref} is the machining time required to perform the same machining on the same punch, but using a brass wire with 40 atomic % zinc and no coating.

It was found that the machining efficiency of the first wire was 1.64 times greater than the machining efficiency of the second wire. This indicates that the first wire machines faster than an identical wire in which the zinc oxide is not enriched with chlorine.

FIG. 3 shows a second method for manufacturing wire 2. The method shown in FIG. 3 is identical to the method shown in FIG. 2, except that step 80 is replaced by step 90 and the final drawing step 84 is omitted.

Step 90 is identical to step 80, except that the diameter Do of the brass blank wire supplied is equal to D₂−e₁₂. Then, in step 82, the thickness e₀ is chosen to be equal to the thickness e₁₂. Thus, after step 82, wire 2 of diameter D₂ is obtained directly without the need for a drawing step to reduce the diameter of the oxidized blank wire.

In this second method, step 84 can be omitted, as the temperature of the blank wire during oxidation step 82 does not exceed 250 °C or 200 °C, so that even without final drawing, the breaking load remains above 700 N/mm². With this second manufacturing method, since there is no final drawing, the thickness e₀ can be chosen to be greater than 522 nm or 600 nm, enabling a wire 2 to be produced whose thickness e₁₂ is greater than 522 nm or 600 nm.

FIG. 4 shows a third method for manufacturing wire 2. This method is similar to the previous ones, except that zinc oxidation and chlorine enrichment are not carried out at the same time.

This method begins with a step 92 of supplying a blank wire. This step 92 is identical to step 80 except that the diameter Do is between 1.3*D₂ and 6*D₂.

Then, in step 94, the blank wire is oxidized to obtain an oxidized blank wire. This step 94 is identical to step 82 except that the heat treatment is carried out in the absence of chlorine. To achieve this, the blank wire is not dipped in the aqueous zinc chloride solution. Because of the absence of chlorine, the rate of zinc oxidation in step 94 is slower. It has been estimated that the values of the parameters k and Q in relation (4) are then equal to 2.418*10⁻⁷ m²/s and 152 KJ/mol respectively. To compensate for this slower oxidation rate while maintaining an acceptable D_{four} duration, the temperature T_{four} is generally chosen between 400 °C and 500 °C.

At the end of step 94, the zinc oxide in the oxidized blank wire is not enriched with chlorine.

Once step 94 has been completed, the oxidized and cooled blank wire is drawn to the desired diameter D₂ in step 96. Step 96 is, for example, identical to step 84.

Before step 96 or after step 96, in a step 98, the zinc oxide is enriched with chlorine. In FIG. 4, step 98 is illustrated as taking place after step 96. In all cases, step 98 is carried out after heat treatment, i.e. after the oxidized blank wire has cooled to room temperature.

In step 98, the zinc oxide produced in step 94 is brought into contact with a chlorine compound. For example, the wire is soaked in a solution containing the chlorine compound, such as an aqueous solution of zinc chloride at room temperature. Alternatively, the wire can be enclosed in a chamber containing chlorine gas. The time taken for the zinc oxide to come into contact with the chlorine compound is chosen to be sufficiently long for Cl⁻ anions to have time to replace O²⁻ anions in the zinc oxide of initial composition [Zn²⁺, O²⁻] in order to obtain a chlorine-enriched zinc oxide of composition [Zn²⁺, O²⁻₁₋ₓ, Cl⁻₂ₓ], where x is a mole fraction of between 0.01 and 0.25. Step 98 can be carried out at room temperature. It can also be carried out at a slightly higher temperature, for example between 100 °C and 200 °C, while remaining at temperatures below those required to recrystallize the wire core 10.

Hydrogen chloride (HCl) at room temperature is an example of a chlorine compound in the gaseous state that can be used in step 98. Hydrogen chloride occurs naturally in the gaseous state above an aqueous solution of hydrochloric acid, concentrated to around 10%, at room temperature. Thus, in step 98, a coil of the wire oxidized in step 94 can be placed above such an aqueous hydrochloric acid solution. After 24 hours, the zinc oxide in this wire is sufficiently enriched with chlorine to obtain a machining speed higher than that of an identical wire except that it has not been exposed to hydrochloric acid vapors.

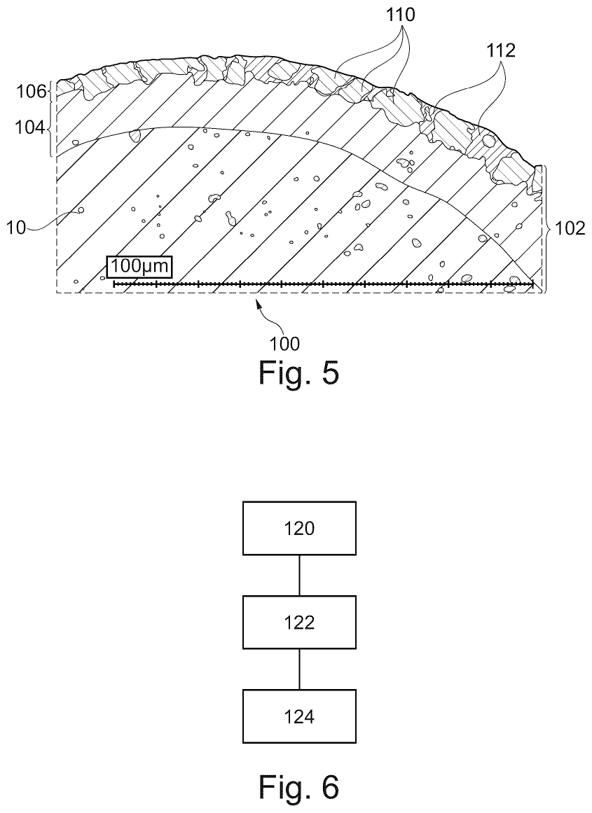

FIG. 5 shows part of the cross-section of an electrode wire 100. This wire 100 is identical to wire 2 except that the coating 12 is replaced by a coating 102.

Starting from the core 10 towards the outside, the coating 102 comprises in succession:
a layer 104 of beta-phase copper-zinc alloy, and
a superficial fractured layer 106.

The layer 106 consists of copper-zinc alloy blocks 110 separated from one another by fractures 112 more or less filled with zinc oxide. In FIG. 5, the numerical references 110 and 112 point only, by way of illustration, to a few examples of blocks and fractures. The majority, and typically more than 90%, of these blocks are essentially gamma-phase copper-zinc alloys. Eventually, these gamma-phase blocks feature a thin beta-phase layer on their faces that have been directly exposed to oxygen during oxidation step 122, described below. This thin beta-phase layer represents only a small fraction of the gamma-phase block. For example, in a cross-section or longitudinal section of a gamma-phase block longer than 5 μm, the thin beta-phase layer represents less than 20% and, generally, less than 10% of the block surface in this section. Since in all cases the proportion of beta phase within a gamma-phase block is low, the term “gamma-phase block” refers both to a block composed entirely of gamma-phase brass and to a block composed essentially of gamma-phase brass with a thin layer of beta-phase brass on its surface.

The zinc oxide contained in layer 106 is chlorine-enriched zinc oxide identical to that described above.

A method for manufacturing wire 100 is now described with reference to FIG. 6.

In a step 120, a blank wire is provided. Here, this blank wire is produced using a process as described in patent U.S. Pat. No. 8,378,247B2. For example, a brass wire with a diameter of 1.25 mm is first supplied. The concentration of zinc in this wire is equal to 40 atomic %. The brass wire is then electrolytically zinc-coated to obtain a zinc-coated brass wire with a 13.4 μm thick zinc layer on its surface. This zinc-coated brass wire is then drawn to obtain a zinc-coated brass wire with a diameter of 0.512 mm and a pure zinc coating thickness of 5.5 μm. This wire is then heat-treated to form a layer of beta-phase copper-zinc alloy surrounded by a surface layer of gamma-phase copper-zinc alloy. For example, a coil of this drawn zinc-coated brass wire is placed in an oven initially at room temperature. The furnace temperature then changes over time as follows:
the temperature is raised to 300 °C at a ramp rate of 300 °C/h, then
oven temperature is maintained at 300 °C for three hours, then
the furnace temperature is raised to 330 °C at a ramp rate of 20 °C/h, then
the oven temperature is maintained at 330 °C for seven hours, then
the oven temperature is lowered to 300 °C at a ramp rate of 30 °C/h, then
the coil is removed from the oven and left to cool to room temperature.

Under these conditions, the thicknesses of the beta and gamma phase layers obtained are equal to 13 μm and 6 μm respectively. A thin film of non-chlorine-enriched zinc oxide is also present on the surface of the gamma-phase layer. The thickness of this thin zinc oxide film is 78 nm.

The heat-treated wire is then drawn. This wire drawing process fractures the gamma-phase surface layer, while the beta-phase layer remains continuous. The fractures separating the gamma-phase blocks open outwards.

The blank wire thus produced comprises, in succession, from the longitudinal axis outwards:
core 10,
layer 104 made of beta-phase copper-zinc alloy,
a fractured layer similar to fractured layer 106, with gamma-phase copper-zinc alloy blocks and fractures that are not, or virtually not, filled with zinc oxide. Moreover, if zinc oxide is present, at this stage it is not enriched in chlorine.

Here, the heat-treated wire is drawn to a diameter of 0.355 mm. The thickness of the 104 layer is 9 μm, the thickness of the fractured layer is 6 μm and the thickness of the thin zinc oxide film is 52 nm.

At the end of step 120, in step 122, the blank wire is oxidized to obtain an oxidized blank wire. To this end, in step 122, the blank wire supplied is subjected to a heat treatment in the presence of oxygen and chlorine. Here, step 122 is carried out by applying the teachings given in the particular case of oxidation step 82. For example, after being soaked for 10 s in the aqueous zinc chloride solution, the blank wire is placed in an oven at 120 °C for 24 h. This oxidation step 122 consumes some of the zinc present on the surface of the gamma-phase blocks, causing, in some cases, the appearance of the thin beta-phase layer on some of the faces of these gamma-phase blocks.

At the end of step 122, a layer of chlorine-enriched zinc oxide covers the fractured layer. In this example, the thickness of the chlorine-enriched zinc oxide layer is 1200 nm.

Finally, in step 124, the oxidized wire obtained in step 122 is drawn to the desired final diameter. Step 124 is carried out under the same conditions as step 84. For example, the oxidized wire is successively passed through four dies to reduce the diameter of the oxidized wire successively to 0.324 mm, 0.296 mm, 0.270 mm and finally 0.25 mm. At the end of step 124, a stress-relief annealing operation, similar or identical to that carried out after step 84, is performed.

During final wire drawing, some of the zinc oxide on the surface of the oxidized wire is pushed back into the fractures of the fractured layer. Thus, at the end of step 124, the majority of fractures 112 between blocks 110 are at least partially filled with chlorine-enriched zinc oxide. The amount of zinc oxide contained within the fractures 112 depends on the thickness of the zinc oxide layer produced in step 122. The greater the thickness of the zinc oxide layer produced in step 122, the more the fractures 112 are filled with chlorine-enriched zinc oxide. At the end of step 124, some of the outer faces of blocks 110 may still be covered with a layer of chlorine-enriched zinc oxide. The outer faces of the blocks 110 are the faces of these blocks facing outwards, i.e. away from the longitudinal axis of the wire. In the particular case of the manufacturing method detailed here, the thickness of the chlorine-enriched zinc oxide layer obtained after this last wire drawing is equal to 500 nm.

The machining speed of wire 100 was compared with the machining speed of a reference wire manufactured using the same manufacturing method except that dipping in the aqueous zinc chloride solution was omitted. It was observed that the machining speed of wire 100 is 1.1 times greater than the machining speed of the reference wire.

### CHAPTER III: VARIANTS

### Electrode Wire Variants:

The metal core is not necessarily made entirely of brass. For example, alternatively, the metal core comprises only a brass surface layer. This brass surface layer is typically thicker than 5 μm or 10 μm. The central part of the metal core is made of another material, such as steel, copper or another metal or metal alloy.

The outer face of coating 12 or 102 may be covered with a thin film of the lubricant used in drawing step 84 or 124.

The thickness of oxide layer 12 can also be greater than 461 nm. For example, the thickness of oxide layer 12 may be greater than 500 nm or 600 nm.

### Manufacturing Method Variants:

Alternatively, the blank wire supplied in steps 80, 90 and 92 comprises a metal core, for example zinc-free, covered with a zinc surface layer. The zinc surface layer is often deposited on the metal core by electrolysis. In such cases, the electrolysis bath may contain a chlorine compound, so that residues of this chlorine compound may remain on the outside of the zinc layer when it leaves the electrolysis bath. However, unless special measures are taken, the residual quantity of this chlorine compound from the electrolysis bath is too small to obtain, after the oxidation step, chlorine-enriched zinc oxide with a mole fraction x greater than 0.01. Thus, unless special measures are taken to preserve a substantial amount of the chlorine compound from the electrolysis bath on the outside of the zinc layer, dipping in the aqueous zinc chloride solution cannot be omitted in this case.

Alternatively, if the blank wire with the desired diameter Do is commercially available, it is not drawn in step 80 before step 82.

Other oxidation steps 82 or 122 are also possible. For example, many other solutions containing a chlorine compound can be used to replace the aqueous zinc chloride solution. For example, a hydrochloric acid solution or a solution containing bleach is also suitable. A solution containing NaCl may also be suitable.

In another variant, the chlorine is deposited on the wire to be treated not by soaking it in a liquid solution containing a chlorine component, but by bringing it into contact with a gas containing a chlorine compound such as dichlor (Cl₂).

Alternatively, instead of placing an entire spool of blank wire in an oven, the blank wire is unwound, passed through a heating tunnel and then wound onto a spool again as it exits the tunnel. Inside the tunnel, the temperature is equal to T_{four}. Thus, in this variant, the blank wire is heated to temperature T_{four} portion after portion. The problem of the time required to obtain a uniform temperature across an entire coil of blank wire is therefore eliminated. In this case, it is possible to use a higher temperature T_{four} and a very short duration D_{four}. For example, when a heating tunnel is used, the temperature value T four can be higher than 300 °C or 400 °C. The speed at which the blank wire passes through the tunnel is then adjusted so that the duration D_{four}, during which a portion of the blank wire remains inside the tunnel, enables the desired thickness e₀ to be achieved.

To obtain a thickness e₁₂ greater than 522 nm, even in the context of the method shown in FIG. 2, the thickness e₀ can be chosen to be greater than 600 nm or 800 nm.

Oxidation step 82 can also be carried out in a medium other than the earth's atmosphere. For example, step 82 can also be carried out in a medium containing more than 20% or 30%, by volume, of oxygen or, on the contrary, depleted in oxygen but with a residual quantity of oxygen sufficient to oxidize the blank wire.

In another variant of step 82, the temperature T_{four} varies over the duration D_{four}. For example, the temperature T_{four} increases continuously over the duration D_{four}. For example, the manufacturing method is as follows: a 60% copper, 40% zinc brass wire with a diameter of 1.25 mm in the annealed state is supplied and then drawn to a diameter of 0.464 mm. The wire with a diameter of 0.464 mm is then soaked in an aqueous zinc chloride solution at 252 g/l and 20 °C (+/−5 °C), for a period of 5 seconds. After soaking in the aqueous zinc chloride solution, the wire is wound onto a steel spool and placed in an oven under air at atmospheric pressure. The temperature T_{four} is then gradually increased from 20 °C to 260 °C at a rate of 10 °C per hour. The duration D_{four} is therefore 24 hours. After D_{four}, the wire is removed from the oven and left to cool in air at room temperature. It is then drawn to a diameter of 0.25 mm using dies with elongations of between 15% and 22% and a lubricant consisting of an oil-in-water emulsion at a temperature of between 20 °C and 80 °C. Finally, the wire is stress-relief annealed. The breaking load of the resulting wire is in excess of 900 N/mm².

In step 120, the blocks of the supplied blank wire can be gamma-phase and epsilon-phase. To achieve this, the heat treatment temperature used to form the beta and gamma phase layers is lowered to form a superimposed gamma and epsilon phase layer instead. For example, this is achieved by lowering the heat treatment temperature to between 130 °C and 160 °C. The thickness of the epsilon-phase layer is small enough that, during drawing, the epsilon-phase layer fractures at the same time as the gamma-phase layer, so that the wire supplied has a fractured layer comprising essentially gamma-phase and epsilon-phase blocks instead of gamma-phase blocks only.

In step 120, the blocks of the blank wire can also be beta phase blocks. For example, to do this, a blank wire containing gamma-phase blocks is first manufactured and then a heat treatment is applied to transform the gamma-phase blocks into beta-phase blocks. Such a method for manufacturing a wire containing essentially beta phase blocks is described in application US2022212277A1.

In another variant, step 124 is omitted. In this case, more than 50% or 70% or 90% of the surface of the outer faces of the blocks 110 of the fractured layer is covered with a chlorine-enriched oxide layer. However, the fractures are not necessarily filled with chlorine-enriched zinc oxide.

Oxidized blank wire can also be cooled in other ways. For example, the furnace is switched off and the coil left inside the furnace until it reaches room temperature.

In a simplified embodiment, stress relief annealing is omitted.

Several of the variants described above can be combined in a single embodiment.

### CHAPTER IV: ADVANTAGES OF THE DESCRIBED EMBODIMENTS

The fact that the coating comprises chlorine-enriched zinc oxide improves machining speed compared with an identical or virtually identical wire in which the zinc oxide is not enriched with chlorine.

The fact that the chlorine-enriched zinc oxide is mainly located within the fractures of a fractured layer not only improves machining speed, but also improves the electrical contact between this wire and the electrodes used when machining a part with it.

The fact that the thickness of the oxide layer is greater than 100 nm improves machining speed and, in particular, enables machining speeds equal to or greater than those of an electrode wire with a fractured gamma-phase copper-zinc alloy coating such as that described in U.S. Pat. No. 8,378,247B2.

The fact that the thickness of the zinc oxide layer is less than 522 nm means that this zinc layer can be produced on a blank wire and then drawn to the final diameter D₂ with very few loss of zinc oxide during the drawing process.

The fact that the zinc oxide layer is formed directly on the peripheral face of the metal core makes it possible to manufacture this zinc oxide layer simply by oxidizing the brass peripheral face of a blank wire. Thus, it is not necessary to deposit a zinc layer on the peripheral face of the blank wire as, for example, in the case of the manufacture of a wire in accordance with the teaching given in patent U.S. Pat. No. 8,378,247B2. In particular, it is emphasized that the electrodeposition of a zinc layer on a blank wire consumes much more energy than the heat treatment step. Thus, the electrode wire in which the oxide layer is formed directly on the brass core can be manufactured by simpler and more economical methods.

Zinc oxidation in the presence of chlorine produces a chlorine-enriched zinc oxide, which increases the machining speed of the electrode wire produced.

The presence of chlorine in the heat treatment used to oxidize zinc also accelerates the oxidation reaction. In this way, the duration of the heat treatment is shorter and/or the temperature of the heat treatment is lower than, respectively, the duration and/or temperature required to obtain the same quantity of zinc oxide but in the absence of chlorine. The presence of chlorine during oxidation therefore speeds up the manufacturing method and/or reduces the heat treatment temperature.

Obtaining the desired amount of zinc oxide by means of a heat treatment that does not exceed 250 °C means that the breaking load of the wire is not degraded during this heat treatment. As a result, it is no longer necessary to subject the oxidized blank wire obtained after this heat treatment to an additional drawing step with a high c₁ coefficient to give it an acceptable breaking load. In addition, such a method makes it easy and efficient to manufacture an electrode wire with an oxide layer thickness e₁₂ greater than 522 nm or 600 nm.

By first oxidizing zinc in the absence of chlorine and then converting this non-chlorine-enriched zinc oxide into chlorine-enriched zinc oxide, chlorine enrichment can be achieved with little or no heating, i.e. at room temperature, for example.

1. An electrode wire suitable for use as an electrode wire for electroerosion machining, the electrode wire comprising:
a metal core extending along a longitudinal axis, and
on the metal core, a coating with a zinc oxide mass per unit area greater than 0.5 g/m²,
wherein the zinc oxide is enriched in chlorine, the composition of the zinc oxide being [Zn²⁺, O²⁻₁₋ₓ, Cl⁻₂ₓ], where x is a molar fraction in a range of from 0.01 to 0.25.

2. The electrode wire according to claim 1, wherein:
the coating comprises a fractured layer with copper-zinc alloy blocks and fractures separating the blocks from each other and from adjacent layers, and
a majority of fractures are at least partially filled with chlorine-enriched zinc oxide.

3. The electrode wire according to claim 1, wherein:
the coating comprises a fractured layer comprising blocks of copper-zinc alloy and fractures separating the blocks from one another, a composition of the blocks being different from a composition of an adjacent layer situated beneath the fractured layer or from that of the metal core situated immediately beneath the fractured layer, and
chlorine-enriched zinc oxide covers at least 50% of a surface area of outward-facing block faces.

4. The electrode wire according to claim 3, wherein a majority of the copper-zinc alloy blocks are gamma-phase copper-zinc alloy blocks.

5. The electrode wire as claimed in claim 1, wherein the coating comprises a layer of chlorine-enriched zinc oxide with an average thickness greater than 100 nm.

6. The electrode wire according to claim 5, wherein the average thickness of the zinc oxide layer is less than 522 nm.

7. The electrode wire according to claim 5, wherein:
the metal core is made of a single copper-zinc alloy, and
the zinc oxide layer is formed directly on a peripheral face of the metal core.

8. The electrode wire according to claim 1, wherein the mole fraction x is in a range of from 0.01 to 0.15.

9. A method for manufacturing an electrode wire, the method comprising:
providing a blank wire whose outer periphery contains zinc or a zinc alloy, then
oxidizing the outer periphery of the blank wire to form a coating with a zinc oxide mass per unit area greater than 0.5 g/m²,
wherein the oxidizing of the outer periphery is carried out in a presence of a chlorine compound, so that the zinc oxide obtained at the end of the oxidizing is a chlorine-enriched zinc oxide,
so as to obtain the electrode wire according to claim 1.

10. The method according to claim 9, wherein the oxidizing of the outer periphery of the blank wire is carried out by subjecting the blank wire to a heat treatment in a presence of oxygen and chlorine.

11. The method according to claim 10, wherein:
in the supplying of the blank wire, the blank wire has a metal core of a single copper-zinc alloy, and
a temperature at which the blank wire is heated during heat treatment remains below 250 °C.

12. The method according to claim 10, comprising, to ensure a presence of chlorine during the heat treatment, before starting the heat treatment, soaking the blank wire in an aqueous zinc chloride solution, the aqueous zinc chloride solution having a concentration of the zinc chloride that makes it possible to deposit a quantity of zinc chloride on the outer face of the blank wire greater than 0.5 g/m².

13. A method of manufacturing an electrode wire, the method comprising:
supplying a blank wire whose outer periphery contains zinc or a zinc alloy, then
oxidizing, in an absence of a chlorine compound, the outer periphery of the blank wire to form a coating with a zinc oxide mass per unit area greater than 0.5 g/m², the zinc oxide being free of chlorine,
wherein, after the oxidizing, the method comprises enriching the zinc oxide with chlorine, wherein the chlorine-free zinc oxide is brought into contact with a chlorine compound so as to transform the zinc oxide obtained at an end of the oxidizing into a zinc oxide enriched with chlorine,
so as to obtain the electrode wire according to claim 1.

14. The method according to claim 13, wherein:
in the supplying of the blank wire, the blank wire comprises a fractured layer of copper-zinc alloy, an outer face of which forms an outer periphery of the blank wire,
then, once the chlorine-enriched zinc oxide has been obtained on an outside of the fractured layer, the method includes drawing the blank wire to push the chlorine-enriched zinc oxide inside the fractures of the fractured layer.

15. The method according to claim 9, wherein:
in the supplying of the blank wire, the blank wire comprises a fractured layer of copper-zinc alloy, an outer face of which forms an outer periphery of the blank wire,
then, once the chlorine-enriched zinc oxide has been obtained on an outside of the fractured layer, the method includes drawing the blank wire to push the chlorine-enriched zinc oxide inside the fractures of the fractured layer.

16. The electrode wire according to claim 2, wherein:
the coating comprises a fractured layer comprising blocks of copper-zinc alloy and fractures separating the blocks from one another, a composition of the blocks being different from a composition of an adjacent layer situated beneath the fractured layer or from that of the metal core situated immediately beneath the fractured layer, and
chlorine-enriched zinc oxide covers at least 50% of a surface area of outward-facing block faces.

17. The electrode wire according to claim 16, wherein a majority of the copper-zinc alloy blocks are gamma-phase copper-zinc alloy blocks.

18. The electrode wire according to claim 6, wherein:
the metal core is made of a single copper-zinc alloy, and
the zinc oxide layer is formed directly on a peripheral face of the metal core.

19. The electrode wire according to claim 2, wherein the mole fraction x is in a range of from 0.01 to 0.15.

20. The electrode wire according to claim 3, wherein the mole fraction x is in a range of from 0.01 to 0.15.
